(19) United States
(12) Patent Application Publication
(10) Pub. No.: US 2026/0187546 A1
(43) Pub. Date: Jul. 2, 2026

(54) RISK ASSESSMENT IN A CHANGE REQUEST

(71) Applicant: Kyndryl, Inc., New York, NY (US)

(72) Inventors: VINAY KUMAR GAJANA HEGDE, BANGALORE (IN); OMAR ODIBAT, CEDAR PARK, TX (US)

(21) Appl. No.: 19/008,125

(22) Filed: Jan. 2, 2025

(51) Int. Cl. G06N 20/20; G06F 18/2413; G06Q 50/00

(52) U.S. Cl. CPC G06N 20/20; G06F 18/24147; G06Q 10/40

(57) ABSTRACT

Embodiments receive a change request for an environment from a first system, predict an impact of the change request of the second system using a first machine learning (ML) model and output an existing system prediction impact based on the predicted impact of the change request of the second system, predict the impact of the change request of at least one third system using a second ML model and output a dependent system prediction impact based on the predicted impact of the change request of the at least one third system, receive historical impact data associated with the change request from a knowledge base, generate an overall predictive score (OPS) based on the existing system prediction impact, the dependent system prediction impact, and the historical impact data, and send an approval decision output signal based on a third ML model which is trained on the OPS.

### BACKGROUND

Aspects of the present invention relate generally to risk assessment in a change request and, more particularly, to systems and methods for providing a risk assessment in a change request using a quantified risk assessment (QRA) model.

A change management process may indicate a risk that occurs during a change request process. Accordingly, the change management process may bucket potential risks based on predefined categories for specialized components.

### SUMMARY

In a first aspect of the invention, there is a computer-implemented method including: receiving, by a computing device, a change request for an environment from a first system; predicting, by the computing device, an impact of the change request of a second system using a first machine learning (ML) model and outputting an existing system prediction impact based on the predicted impact of the change request of the second system; predicting, by the computing device, the impact of the change request of at least one third system using a second ML model and outputting a dependent system prediction impact based on the predicted impact of the change request of the at least one third system; receiving, by the computing device, historical impact data associated with the change request from a knowledge base; generating, by the computing device, an overall predictive score (OPS) based on the existing system prediction impact, the dependent system prediction impact, and the historical impact data; and sending, by the computing device, an approval decision output signal based on a third ML model which is trained on the OPS.

In another aspect of the invention, there is a computer program product including one or more computer readable storage media having program instructions collectively stored on the one or more computer readable storage media. The program instructions are executable to: receive a change request for an environment from a first system; predict an impact of the change request of a second system using a first machine learning (ML) model and output an existing system prediction impact based on the predicted impact of the change request of the second system; predict the impact of the change request of at least one third system using a second ML model and output a dependent system prediction impact based on the predicted impact of the change request of the at least one third system; receive historical impact data associated with the change request from a knowledge base; generate an overall predictive score (OPS) based on the existing system prediction impact, the dependent system prediction impact, and the historical impact data; and send an approval decision output signal based on a third ML model which is trained on the OPS.

In another aspect of the invention, there is a system including a processor, a computer readable memory, one or more computer readable storage media, and program instructions collectively stored on the one or more computer readable storage media. The program instructions are executable to: receive a change request for an environment from a first system; predict an impact of the change request of a second system using a first machine learning (ML) model and output an existing system prediction impact based on the predicted impact of the change request of the second system; predict the impact of the change request of at least one third system using a second ML model and output a dependent system prediction impact based on the predicted impact of the change request of the at least one third system; receive historical impact data associated with the change request from a knowledge base; generate an overall predictive score (OPS) based on the existing system prediction impact, the dependent system prediction impact, and the historical impact data; and send an approval decision output signal based on a third ML model which is trained on the OPS. In further aspects of the present invention, the first ML model and the second ML model is trained using a K-nearest neighbors nomination (KNN) algorithm, and the third ML model is trained using a linear regression algorithm.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a quantified risk assessment system in accordance with aspects of the present invention.

FIG. 5 shows a block diagram of a change management system in accordance with aspects of the present invention.

FIG. 6 shows another block diagram of a cross dependency system in accordance with aspects of the present invention.

FIG. 7 shows a flowchart of an exemplary method of the quantified risk assessment system in accordance with aspects of the present invention.

FIG. 8 shows an example of scoring in accordance with aspects of the present invention.

FIG. 9 shows another flowchart of an exemplary method of the quantified risk assessment system in accordance with aspects of the present invention.

### DETAILED DESCRIPTION

Aspects of the present invention relate generally to risk assessment in a change request and, more particularly, to systems and methods for providing a risk assessment in a change request using a quantified risk assessment (QRA) model. Aspects of the present invention may be implemented as a system, method, or computer program product. The system, method, or computer program product includes a QRA system which covers all system relationships, such as direct dependencies based on direct mapping and indirect effects based on indirect mapping. In addition, the system, method, or computer program product analyzes potential impacts of all physical and virtual components including user impacts, business impacts, system impacts, etc. The system, method, and/or computer program product includes a change manager to create a change impact score based on various viewpoints from an original equipment manufacturer (OEM) guide, knowledge base, blogs, videos, and text-based inputs from social media. Aspects of the present invention calculate a success rate score of essential changes for the change request to be applied and prepares a restoration plan. Accordingly, the system, method, and/or computer program product provides a listing of components that will get impacted due to the change request based on an open systems interconnection (OSI) model which covers all of the system relationships. The systems and methods provided herein may be computer implemented methods.

More specifically, the system, method, or computer program product described herein quantifies an external input from OEM guides, blogs, social media, learning from an existing knowledge base based on sentiment feedback (e.g., thumbs up or thumbs down, positive or negative feedback, etc.), credibility of an author, and relevance by using keywords search related to a component that needs be changed. The system, method, or computer program establishes a hierarchical relationships and determines impacts across sub-categories such as service packs, firmware, basic input/output system (BIOS), etc., and covers a detailed view of a potential upgrade. Further, the system, method, or computer program product approves or disapproves major change requests based on quantitative data. In further embodiments, the system, method, or computer program product verifies all aspects of the system based on quantitative data and a scoring mechanism (e.g., k-nearest neighbors (KNN) model). Further, embodiments of the present invention provides a comprehensive view to a change advisory board (CAB) to approve change requests based on a system scenario and asset-based viewpoint. Accordingly, implementation of the present invention are configured to provide the comprehensive view to approve a change request based on assets such as motherboards, components, end user devices and business impacts.

Aspects of the present invention identifies and addresses all of the potential areas in the system in which the impact of a change request is unknown. Embodiments of the present invention also identifies and addresses all high-risk segments and components within the system that are impacted by a change request. In addition, embodiments of the present invention map all dependencies within layers of the system such that the impact of dependent relationships and result oriented relationships can be measured within the system.

Embodiments of the present invention provide a computer-implemented method, a system, and a computer program product for assessing change request risk using a layer segmentation model. In aspects of the present invention, the computer-implemented method, the system, and the computer program product receives a change request for an information technology (IT) environment; identifies, based on the change request, one or more systems associated with the change request, the one or more systems included in the IT environment; receiving, from a knowledge base, historical impact data associated with the change request; generating, based on the identified one or more systems and one or more dependent systems which are dependent on the identified one or more systems, a systems risk score; determining, based on the historical impact data and the system risk score, whether to execute the change request; and notifying the user of the determination. In further embodiments of the present invention, the generating the systems risk score comprises analyzing a set of physical system components of the one or more systems; analyzing a set of system features; assessing a set of relationships of an open systems interconnection (OSI) layer; assessing a set of OSI layer dependencies; and calculating, based on the physical system component analysis, the system features analysis, the OSI layer relationships assessment, and the OSI layer dependencies assessment, the systems risk score. In further embodiments of the present invention, the historical impact data includes one or more post-change-request-execution reports associated with other instances of the change request having been executed in an IT environment. In further embodiments of the present invention, the analysis of the set of the physical component considers risk data associated with a set of unique identifiers associated with hardware models included in the set of physical components; risk data associated with one or more operating system (OS) utilized within the IT environment; and risk data associated with a set of firmware utilized by the one or more OS to control the set of physical components.

In contrast, known systems perform a risk assessment for a change implementation which is subjective in nature based on predefined categories such as low, medium, and high and does not include any quantifiable data to indicate a success or a failure of the change implementation. Further, known systems are driven by human experience and doesn't indicate any scope of automating a change implementation. For example, known systems test change requests in a standard environment which only considers a latest version of an operating system (OS), a tool, and/or a system. However, known systems have subjective gaps in change management such as not accounting for indirect dependencies and result relationships. Further, known systems merely rely on mapping direct dependencies and subjective analysis. The systems, methods, and computer program products as described herein make improvements on known systems by considering all conditions of dependent systems such as physical, virtual, logical and system context, and OSI layers within the system. Further, the systems, methods, and computer program products make improvements on known systems by quantifying an effect of a change request so that approved changes can be implemented with minimal disruption to the system. In addition, the systems, methods, and computer program products suggest a best available solution for the risk assessment based on gathering and analyzing information from various levels of the system. Further, implementations of the present invention predict an impact of a change request based on the system configuration, the system conditions, and dependency mapping. Lastly, embodiments of the present invention are able to quantify a success rate of repeated change requests and automating an approval or denial of the repeated change requests.

Implementations of the present invention are also rooted in computer technology. For example, the steps of training, by a computing device, a machine learning (ML) model which is trained on a historical change impact, an impact on existing system, a potential change impact based on OEM, blogs, and social media, and generating, by the computing device, a risk score based on the trained ML model to determine whether a change request should be approved are computer-based and cannot be performed in the human mind. For example, training the ML model on the historical change impact, the impact on the existing system, and the potential change impact based on OEM, blogs, and social media and generating a risk score based on the trained ML model to determine whether to approve a change request are by definition, performed by a computer and cannot practically be performed in the human mind (or with pen and paper) due to the complexity and massive amounts of calculations involved. Given the scale and complexity of training the ML model, it is simply not possible for the human mind, or for a person using pen and paper, to perform the number of calculations involved in determining whether to approve a change request based on the trained ML model in real-time, amongst other features described herein that are also rooted in computer technology.

It should be understood that, to the extent implementations of the invention collect, store, or employ personal information provided by, or obtained from, individuals (for example, user review of change requests), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

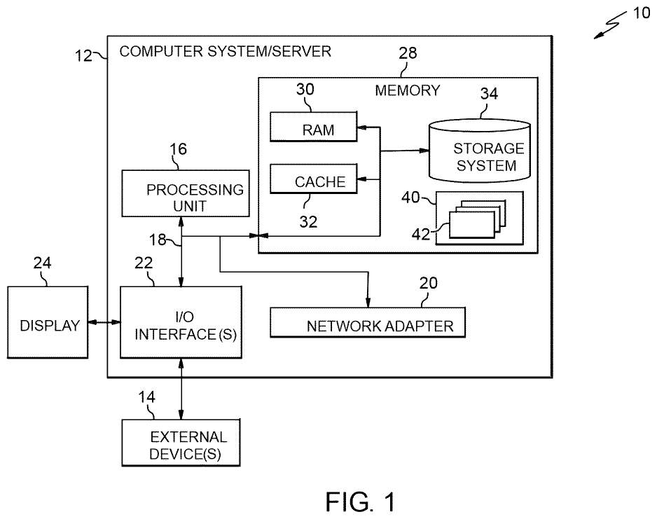

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

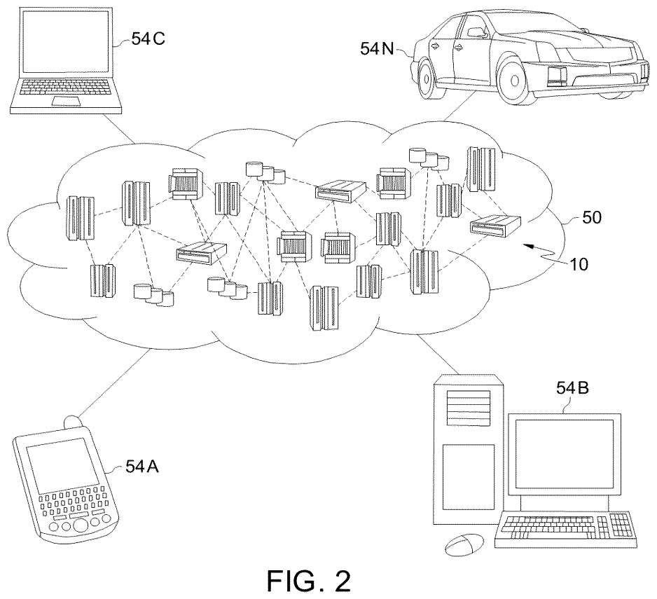

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

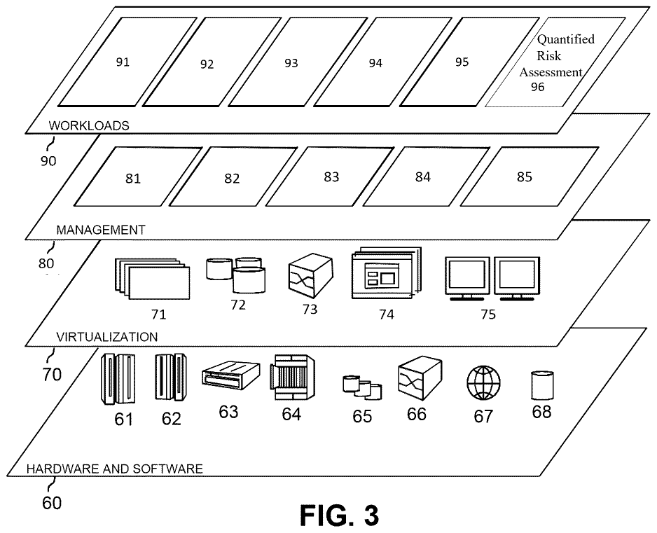

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and quantified risk assessment 96.

Implementations of the invention may include a computer system/server 12 of FIG. 1 in which one or more of the program modules 42 are configured to perform (or cause the computer system/server 12 to perform) one of more functions of the quantified risk assessment 96 of FIG. 3. For example, the one or more of the program modules 42 of the quantified risk assessment 96 may be configured to: receive a change request for an environment from an external system; predict an impact of the change request of the existing system using a first machine learning (ML) model and output an existing system prediction impact based on the predicted impact of the change request of the existing system; predict the impact of the change request of at least one dependent system using a second ML model and output a dependent system prediction impact based on the predicted impact of the change request of the at least one dependent system; receive historical impact data associated with the change request from a knowledge base; generate an overall predictive score (OPS) based on the existing system prediction pact, the dependent system prediction impact, and the historical impact data; and send an approval decision output signal based on a third ML model which is trained on the OPS.

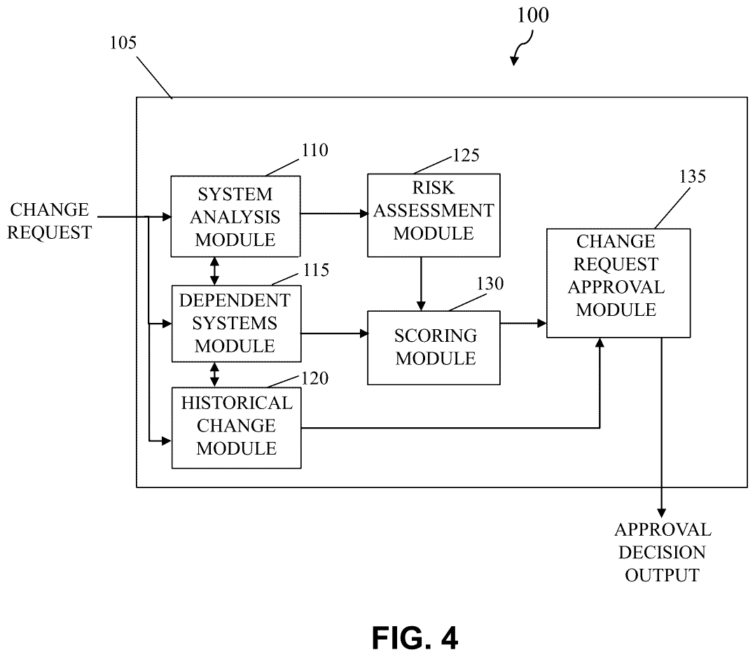

FIG. 4 shows a block diagram of a quantified risk assessment system in accordance with aspects of the invention. In embodiments, the quantified risk assessment system 100 comprises a quantified risk assessment environment 105 which includes a systems analysis module 110, a dependent systems module 115, a historical change module 120, a risk assessment module 125, a scoring module 130, and a change request approval module 135, each of which may comprise one or more program modules such as program modules 42 described with respect to FIG. 1 and the quantified risk assessment 96 of FIG. 3.

The quantified risk assessment system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the quantified risk assessment system 100 enables the system, method, and computer-program product to provide a mapping of direct dependencies and indirect dependencies before and after implementation of a proposed change request. In further embodiments, the quantified risk assessment system 100 provides a mapping of a result relationship including a last layer approach, a last impact approach, a last person approach, and a last point approach. In further embodiments, the quantified risk assessment system 100 maps dependencies including a direct relationship with a component, a host system that is affected by a change request, and a business unit that is affected by the change request. For example, the quantified risk assessment system 100 may map virtual machines, a storage area network (SAN), a computing device, a network, a storage device, input/output operations, applications, etc.

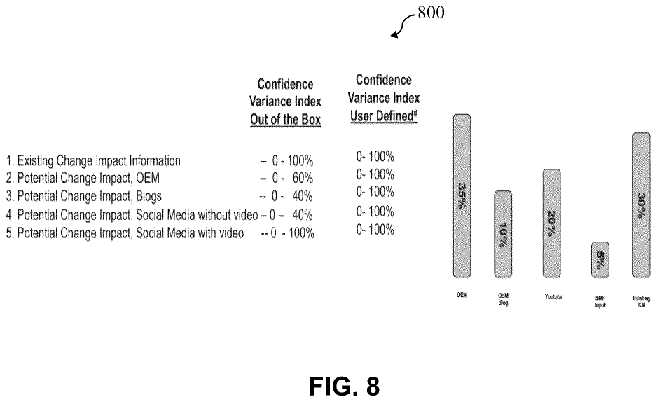

In further embodiments, the system analysis module 110 receives a change request. In aspects of the present invention, the change request represents a change that will affect the environment of the existing system (e.g., the quantified risk assessment system 100). In further embodiments, the change request is received from an external system (e.g., external system or external application from the quantified risk assessment environment 105). In aspects of the present invention, the system analysis module 110 analyzes the change request and determines an existing system that would be indirectly or directly affected by the change request. In particular, the system analysis module 110 analyzes an impact of the change request on the existing system, which may include at least one of hardware, firmware, an operating system (OS), system applications, settings, configurations, a user profile, third party applications, security applications and settings, etc. For example, the system analysis module 110 comprises a first machine learning (ML) model which is trained on existing change impact data, potential change impact data from an OEM, potential change impact data from a blog, potential change impact from social media without video, and potential change impact from social medio with video for the existing system using a K-nearest neighbors nomination (KNN) algorithm. Further details of the KNN algorithm will be explained in FIG. 8. In other embodiments, the first ML model may be trained using a page ranking algorithm. In further embodiments, the existing change impact data is based on historical change impact data for the existing system in a knowledge database from the historical change module 120. In aspects of the present invention, the first ML model of the systems analysis module 110 can be trained by performing feature analysis to utilize current and previous versions (e.g., n current version with the system, n−1 last version within the system, n−2 previous version before the last version within the system, . . . , etc.), current and previous hurdles and blockages, etc., of the change impact data for the existing system. In other words, the first ML model can be trained with both current and previous versions of the existing system to enhance accuracy and incorporate previous versions of an environment of the existing system. In this situation, the system analysis module 110 utilizes the first trained ML model to analyze the impact of the change request on the existing system and outputs an existing system prediction impact which predicts an impact of the change request on the existing system. In embodiments, the first trained ML model improves accuracy of the existing system predication impact based on incorporating more and more existing and historical change impact data for the existing system. In aspects of the present invention, the system analysis module 110 outputs the existing system prediction impact to the risk assessment module 125.

In aspects of the present invention, the dependent systems module 115 receives the change request. In embodiments, the dependent systems module 115 analyzes the change request and determines the dependent systems that would be indirectly or directly affected by the change request. In particular, the dependent systems module 115 analyzes an impact of the change request on the dependent systems, which may include an asset within an asset management system (e.g., firmware). In further embodiments, the dependent systems module 115 comprises a second ML model which is trained on existing change impact data, potential change impact data from an OEM, potential change impact data from a blog, potential change impact from social media without video, and potential change impact from social medio with video for the dependent systems using the KNN algorithm. Further details of the KNN algorithm will be explained in FIG. 8. In other embodiments, the second ML model may be trained using a page ranking algorithm. In further embodiments, the existing change impact data is based on historical change impact data for the dependent systems in the knowledge database from the historical change module 120. In this situation, the dependent systems module 115 utilizes the second trained ML model to analyze the impact of the change request on the dependent systems and outputs a dependent system prediction impact which predicts an impact of the change request on the dependent systems. In embodiments, the second trained ML model improves accuracy of the dependent system predication impact based on incorporating more and more existing and historical change impact data for the dependent systems. In aspects of the present invention, the dependent systems module 115 outputs the dependent system prediction impact to the scoring module 130.

In embodiments of the present invention, the historical change module 120 also receives the change request. In further embodiments, the historical change module 120 comprises the knowledge database. Therefore, the historical change module 120 analyzes the received change request to determine the historical change impact for the existing system based on the received change request and historical change impact data for the existing system in the knowledge database. The historical change module 120 then sends the historical change impact data for the existing system to the system analysis module 110 via the dependent systems module 115. The historical change module 120 also analyzes the received change request to determine the historical change impact for the dependent systems based on the received change request and historical change impact data for the dependent systems in the knowledge database. The historical change module 120 then sends the historical change impact data for the existing system to the system analysis module 110. Lastly, the historical change module 120 sends the historical change impact for the existing system and the historical change impact for the dependent systems to the change request approval module 135.

In further embodiments of the present invention, the risk assessment module 125 receives the existing system prediction impact from the systems analysis module 110. In aspects of the present invention, the risk assessment module 125 receives the existing system predication impact and performs a risk assessment across all of the open systems interconnection (OSI) layers. In particular, the risk assessment module 125 performs the risk assessment across an application layer, a presentation layer, a session layer, a transport layer, a network layer, a data link layer, and a physical layer of the OSI layers. In aspects of the present invention, the risk assessment module 125 performs a risk assessment across hardware, software, firmware, OS, OS service packs, applications, profiles, settings, access, agents, topology mapping, rights within a directory, and other related components across all of the OSI layers. The risk assessment module 125 then sends the existing system prediction impact and the risk assessment across the OSI layers to the scoring module 130.

In aspects of the present invention, the scoring module 130 receives the existing system prediction impact, the risk assessment across the OSI layers, and the dependent system prediction impact. In embodiments, the scoring module 130 calculates a confidence variance index out of a box for the existing system prediction impact, the risk assessment across the OSI layers, and the dependent system prediction impact. In further embodiments, the confidence variance index out of the box represents an actual weighting of each of the existing change impact data, potential change impact data from an OEM, potential change impact data from a blog, potential change impact from social media without video, and potential change impact from social medio with video for the existing system, the dependent system, and the risk assessment across the OSI layers. In addition, the sum of the weighting of each the existing change impact data, potential change impact data from an OEM, potential change impact data from a blog, potential change impact from social media without video, and potential change impact from social medio with video for the confidence variance index out of the box adds up to 100%. In aspects of the present invention, the scoring module calculates a confidence variance user defined for the existing system prediction impact, the risk assessment across the OSI layers, and the dependent system prediction impact. In further embodiments, the confidence variance index out of the box represents a user defined weighting from a subject matter expert (or other user or developer of the quantified risk assessment system 100) of each of the existing change impact data, potential change impact data from an OEM, potential change impact data from a blog, potential change impact from social media without video, and potential change impact from social medio with video for the existing system, the dependent system, and the risk assessment across the OSI layers. In addition, the sum of the weighting of each the existing change impact data, potential change impact data from an OEM, potential change impact data from a blog, potential change impact from social media without video, and potential change impact from social medio with video the confidence variance index user defined adds up to 100%.

In further aspects of the present invention, the scoring module 130 utilizes the calculated confidence variance out of the box, the calculated confidence variance user defined, the existing system prediction impact, the risk assessment across the OSI layers, and the dependent system prediction impact to determine an overall predictive score (OPS). In particular, the OPS is represented by standard condition of an environment (SCE) plus relationship (R) minus existing system condition with acceptable deviation (ESCD). As shown below, the equation for the OPS is as follows:

$$OPS = SCE + R - ESCD . \qquad ( Equation 1 )$$

In Equation 1, the standard condition of the environment represents a numerical factor which corresponds with a set of normalized conditions for an environment in which there are no change requests or major alterations to the environment. In Equation 1, the relationship represents a numerical factor which corresponds to a direct effect or an indirect effect on the standard condition of the environment. In Equation 1, the existing system condition with acceptable deviation represents a numerical factor which corresponds with an existing system condition with the acceptable deviation. In further aspects, the acceptable deviation may be user defined by a subject matter expert. Accordingly, the overall predictive score (OPS) is a comparison of the standard condition with the existing system with the acceptable deviation and represents a score which indicates to a user or subject matter expect whether the change request should be accepted. In further embodiments of the scoring module 130, a high score for the OPS represents a high probability of approval for the change request and a low score for the OPS represents a low probability of approval for the change request. In particular, the high score for the OPS corresponds with a low negative impact of the change request on the environment and existing system and the low score for the OPS corresponds with a high negative impact of the change request on the environment and existing system. The scoring module 130 sends the OPS to the change request approval module 135.

The change request approval module 135 receives the OPS from the scoring module 130 and the historical change impact for the existing system and the historical change impact for the dependent systems from the historical change module 120. The change request approval module 135 then utilizes a third machine learning (ML) model which is trained on the OPS, the historical change impact for the existing system, and the historical change impact for the dependent systems using a linear regression algorithm. In other embodiments, the third ML model is trained using a random forest algorithm. In further embodiments, the change request approval module 135 utilizes the third trained ML model to analyze the impact of the change request and outputs an approval decision output signal which is used to trigger whether the change request is implemented in the existing system or not. In embodiments, the third trained ML model improves accuracy of the approval decision output signal based on incorporating more and more existing and historical data for the OPS, the historical change impact for the existing system, and the historical change impact for the dependent systems. In aspects of the present invention, the approval decision output signal may comprise an approve decision which triggers the change request to be approved and implemented throughout the existing system. Alternatively, the approval decision output signal may comprise a denial decision which triggers the change request to be denied and not implemented in the existing system. Although FIG. 4 shows the change request approval module 135 sending the approval decision output signal outside the quantified risk assessment environment 105, embodiments are not limited and the approval decision output signal may be kept within the quantified risk assessment environment 105.

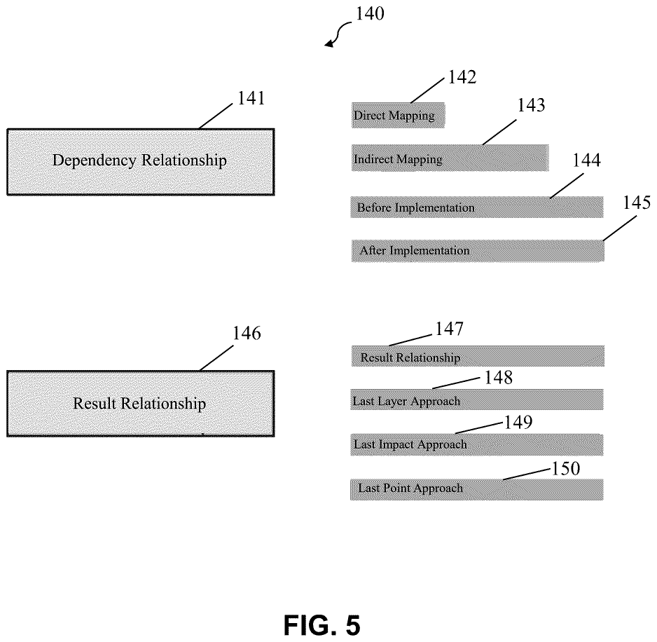

FIG. 5 shows a block diagram of a change management system in accordance with aspects of the present invention. In FIG. 5, the block diagram 140 of the change management system comprises a dependency relationship 141 which includes a direct mapping 142 in which there is a one to one relationship in the existing system to a potential change request within the change management system. For example, an OS installed in a server has a direct mapping 142 to the potential change request such that approval of the potential change request will directly impact the OS installed in the server because of the direct mapping 142. The dependency relationship 141 also includes an indirect mapping 143 in which there is a second order, third order, etc., relationship in the existing system to the potential change requesting within the change management system. For example, there is an indirect impact to an application being used by an end user when an application server gets patched up with a potential change request because of the indirect mapping 143. In further embodiments of the present invention, the quantified risk assessment system 100 may provide implementation of different assets changes before implementation 144 of the potential change request. For example, the quantified risk assessment system 100 may provision more storage for the OS before implementation 144 of the potential change request to mitigate the impact of the potential change request. In addition, the quantified risk assessment system 100 may provide implementation of different assets after implementation 145 of the potential change request. For example, the quantified risk assessment system 100 may update application patches after implementation 145 of the potential change request (e.g., patching up the application server in this example).

In embodiments of FIG. 5, the block diagram 140 comprises a result relationship 146 which includes a last layer approach 147. In embodiments, the last layer approach 147 considers all domains while implementing the potential change request. For example, the last layer approach 147 considers clock speed, firmware, etc., within all domains. In embodiments, the result relationship 146 also includes a last impact approach 148. In embodiments, the last impact approach 148 considers the smallest and last impact. For example, the last impact approach 148 considers memory and processor impacts, which typically are the smallest and last impact within the environment. In aspects of the present invention, the result relationship 146 also includes a last person approach 149. In embodiments, the last person approach 149 considers the last user or last consumer. For example, the last person approach 149 considers indirect users which are last users within the environment. In further embodiments, the result relationship 146 also includes a last point approach 150. In aspects of the present invention, the last point approach 150 considers a last related device. For example, the last point approach 150 considers a last device which is connected to the environment thru a network.

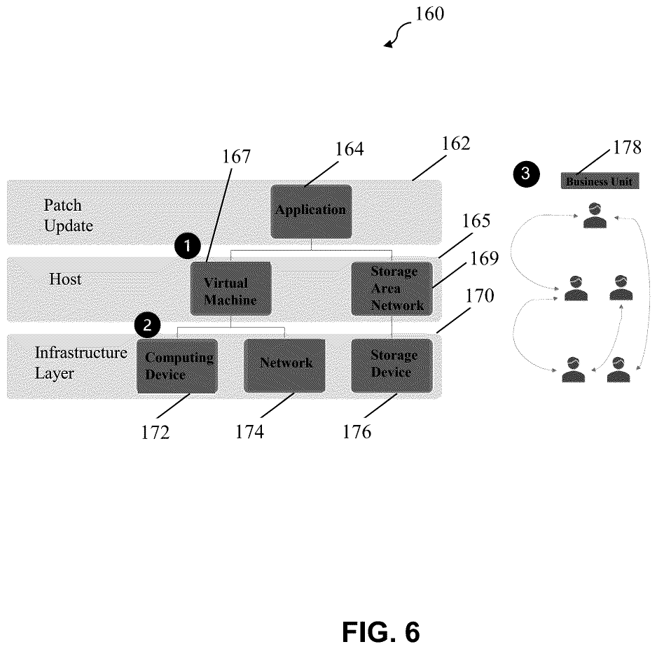

FIG. 6 shows another block diagram of a cross dependency system in accordance with aspects of the present invention. In FIG. 6, the block diagram 160 of the cross dependency system includes a change request which includes a patch update 162, a host 165, and an infrastructure layer 170. In an example, the patch update 162 may directly affect a database application 164 and has a direct relationship 1 with the host 165. In particular, the patch update 162 may directly affect a virtual machine 167 and a storage area network (SAN) 169 through the direct relationship 1. Further, the patch update 162 may also affect 2 the infrastructure layer 170. In an example, the patch update 162 may affect 2 (e.g., impact) the computing device 172 (e.g., performing central processing unit (CPU) cycles), the network 174, and the storage device 176 (e.g., performing input/output operations per second) thru the infrastructure layer 170. In further embodiments, the patch update 162 also affects 3 a business unit 178. In an example, the patch update 162 may impact the application, the computing device, the storage device, and the network of the business unit 178. In further embodiments, the application, the computing device, the storage device, and the network may share information with each other in the business unit 178.

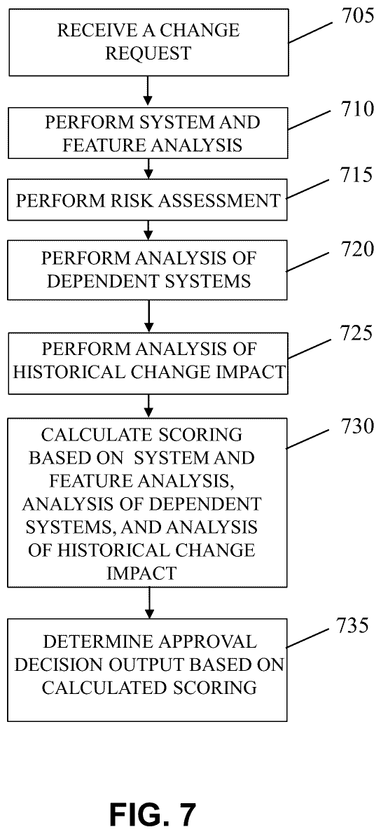

FIG. 7 shows a flowchart of an exemplary method of the quantum risk assessment system in accordance with aspects of the present invention. Steps of the method may be carried out in the quantified risk assessment environment 105 of FIG. 4.

At step 705, the system receives, at the system analysis module 110, a change request. In embodiments and as described with respect to FIG. 4, the change request represents a change that will affect the environment of the existing system. At step 710, the system performs, at the system analysis module 110, a system analysis and a feature analysis for the existing system. In embodiments and as described with respect to FIG. 4, the system analysis module 110 performs the system analysis and the features analysis for the existing system by utilizing a first trained ML model to predict an impact of the change request of the existing system and output an existing system prediction impact. At step 715, the system performs, at the risk assessment module 125, a risk assessment based on the existing system prediction impact. In embodiments and as described with respect to FIG. 4, the risk assessment module 125 performs the risk assessment across open systems interconnection (OSI) layers.

At step 720, the system performs, at the dependent systems module 115, analysis of the dependent systems. In embodiments and as described with respect to FIG. 4, the dependent systems module 115 analyzes the change request and determines the dependent system that are indirectly or directly affected by the change request. The dependent systems module 115 also performs analysis of the dependent systems by utilizing a second trained ML model to predict an impact of the change request on the dependent systems and output a dependent system prediction impact. At step 725, the system performs, at the historical change module 120, analysis of the historical change impact for the existing system and the dependent systems. In embodiments and as described with respect to FIG. 4, the historical change module 120 outputs the historical change impact for the existing system and the historical change impact for the dependent systems.

At step 730, the system calculates, at the scoring module 130, an overall predictive score (OPS) based on the system and features analysis performed by the systems analysis module 110, the analysis of the dependent systems performed by the dependent systems module 115, and the analysis of the historical change impact performed by the historical change module 120. In embodiments and as described with respect to FIG. 4, the scoring module 130 calculates the OPS based on the historical change impact for the existing system and the historical change impact for the dependent systems, the risk assessment across OSI layers, the existing system prediction impact, and the dependent system prediction impact. At step 735, the system outputs, at the change request approval module 135, the approval decision output signal based on the OPS, the historical change impact for the existing system, and the historical change impact for the dependent systems. In embodiments and as described with respect to FIG. 4, the approval decision output signal triggers either implementation of the change request for the environment of the existing system or prevention of the implementation of the change request for the environment of the existing system.

FIG. 8 shows an example of scoring in accordance with aspects of the present invention. In the example of the scoring 800, the scoring module 130 calculates a confidence variance index out of a box for the existing system prediction impact, the risk assessment across the OSI layers, and the dependent system prediction impact. In further embodiments, the confidence variance index out of the box represents an actual weighting of each of the existing change impact information (e.g., up to 100%), potential change impact data from an OEM (e.g., up to 60%), potential change impact data from blogs (e.g., up to 40%), potential change impact from social media without video (e.g., up to 40%), and potential change impact from social medio with video (e.g., up to 100%) for the existing system, the dependent system, and the risk assessment across the OSI layers. In aspects of the present invention, the scoring module 130 also calculates a confidence variance index user defined for the existing system prediction impact, the risk assessment across the OSI layers, and the dependent system prediction impact. In further aspects of the present invention, the confidence variance index user defined represents a user defined weighting from a subject matter expert of each of the existing change impact information (e.g., up to 100%), potential change impact data from an OEM (e.g., up to 100%), potential change impact data from blogs (e.g., up to 100%), potential change impact from social media without video (e.g., up to 100%), and potential change impact from social medio with video (e.g., up to 100%) for the existing system, the dependent system, and the risk assessment across the OSI layers. In an example of the scoring 800, the confidence variance index out of the box represents the potential change impact from the OEM at 35%, the potential change impact from the OEM blog at 10%, the potential change impact from social media with video (e.g., YouTube) at 20%, the potential change impact from social media without video (e.g., SME input) at 10%, and the existing change impact information (e.g., existing KM) at 30%. In the example, the sum of the potential change impact from the OEM, the potential change impact from the OEM blog, the potential change impact from social media with video (e.g., YouTube), the potential change impact from social media without video (e.g., SME input), and the existing change impact information (e.g., existing KM) is 100%. In embodiments, any increase in one component would decrease other components so that the total sum would stay at 100%. In further embodiments, the confidence variance index out of the box components are based on a percentage allocation by a user, related links, information, and/or the data summary.

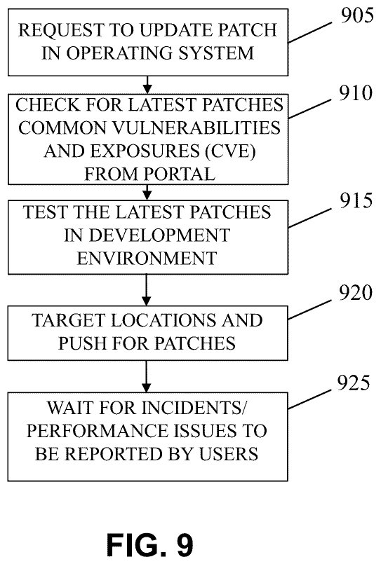

FIG. 9 shows another flowchart of an exemplary method of the quantified risk assessment system in accordance with aspects of the present invention. Steps of the method may be carried out in the quantified risk assessment environment 105 of FIG. 4.

At step 905, the system receives, at the system analysis module 110, a request to update a patch in an operating system. In embodiments and as described with respect to FIG. 4, the system analysis module 110 checks the operating system (e.g., Windows 11), hosting hardware, firmware, and virtual machines, other applications, and the user profile to determine whether the patch in the operating system needs to be updated.

At step 910, the system checks, at the system analysis model 110 and the risk assessment module 125, common vulnerabilities and exposure (CVE) for latest patches from a portal. In embodiments and as described with respect to FIG. 4, the system analysis module 110 and the risk assessment module 125 checks CVE for latest patches from the portal by checking for vulnerabilities from a knowledge database, OEM blogs, partner portals, social media, and other secondary sources and quantifying the risks based on negative feedback for the patch by utilizing at least one trained ML model.

At step 915, the system tests, at the system analysis module 110, the risk assessment module 125, and the change request approval module 135, the latest patches in a development environment (e.g., the quantified risk assessment environment 105). In embodiments and as described with respect to FIG. 4, the system analysis module 110 and the risk assessment module 125 tests the latest patches in quantified risk areas of development environment, validates the quantified risk areas, and highlights the validated quantified risk areas to a change advisory board (CAB). Further, the system analysis module 110, the risk assessment module 125, and the change request approval module 135 prepares contingency plans for the verified quantified risk areas and approves or disapproves the request to update the patch based on the type of the quantified risk areas, mitigation level, and implementation effects based on the quantified negative feedback by utilizing the at least one trained ML model.

At step 920, the system targets, at the system analysis module 110, the risk assessment module 125, and the change request approval module 135, locations for updating the patches in the development environment and pushes the patches to the locations in the development environment. At step 925, the system waits for, at the system analysis module 110, incidents/performance issues to be reported by users.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, a change request for an environment from a first system;
predicting, by the computing device, an impact of the change request of a second system using a first machine learning (ML) model and outputting an existing system prediction impact based on the predicted impact of the change request of the second system;
predicting, by the computing device, the impact of the change request of at least one third system using a second ML model and outputting a dependent system prediction impact based on the predicted impact of the change request of the at least one third system;
receiving, by the computing device, historical impact data associated with the change request from a knowledge base;
generating, by the computing device, an overall predictive score (OPS) based on the existing system prediction impact, the dependent system prediction impact, and the historical impact data; and
sending, by the computing device, an approval decision output signal based on a third ML model which is trained on the OPS.

2. The computer-implemented method of claim 1, further comprising training, by the computing device, the first ML model using at least one of existing change impact data, potential change impact data from an original equipment manufacturer (OEM), the potential change impact data from a blog, the potential change impact data from social media without video, or the potential change data from social media with video for the second system.

3. The computer-implemented method of claim 2, wherein the first ML model is trained using a K-nearest neighbors nomination (KNN) algorithm.

4. The computer-implemented method of claim 1, further comprising training, by the computing device, the second ML model using at least one of existing change impact data, potential change impact data from an original equipment manufacturer (OEM), the potential change impact data from a blog, the potential change impact data from social media without video, or the potential change data from social media with video for the at least one third system.

5. The computer-implemented method of claim 4, wherein the second ML model is trained using a K-nearest neighbors nomination (KNN) algorithm.

6. The computer-implemented method of claim 1, wherein the third ML model is trained using a linear regression algorithm.

7. The computer-implemented method of claim 1, wherein the third ML model is trained using a random forest algorithm.

8. The computer-implemented method of claim 1, wherein the change request represents a change that will affect the environment of the second system.

9. The computer-implemented method of claim 1, wherein the generated OPS is based on a standard condition of the environment, a relationship, and an existing system condition with acceptable deviation.

10. The computer-implemented method of claim 1, wherein the second system comprises at least one of hardware, firmware, an operating system (OS), a system application, settings, a configuration, a user profile, a third party application, or a security application.

11. The computer-implemented method of claim 1, wherein the at least one third system is dependent on the second system, the first system comprises an external system, the second system comprises an existing system, and the at least one third system comprises at least one dependent system.

12. A computer program product comprising one or more computer readable storage media having program instructions collectively stored on the one or more computer readable storage media, the program instructions executable to:
receive a change request for an environment from a first system;
predict an impact of the change request of a second system using a first machine learning (ML) model and output an existing system prediction impact based on the predicted impact of the change request of the second system;
predict the impact of the change request of at least one third system using a second ML model and output a dependent system prediction impact based on the predicted impact of the change request of the at least one third system;
receive historical impact data associated with the change request from a knowledge base;
generate an overall predictive score (OPS) based on the existing system prediction impact, the dependent system prediction impact, and the historical impact data; and
send an approval decision output signal based on a third ML model which is trained on the OPS.

13. The computer program product of claim 12, wherein the program instructions are executable to train the first ML model using at least one of existing change impact data, potential change impact data from an original equipment manufacturer (OEM), the potential change impact data from a blog, the potential change impact data from social media without video, and the potential change data from social media with video for the second system.

14. The computer program product of claim 13, wherein the first ML model is trained using a K-nearest neighbors nomination (KNN) algorithm.

15. The computer program product of claim 12, wherein the program instructions are executable to train the second ML model using at least one of existing change impact data, potential change impact data from an original equipment manufacturer (OEM), the potential change impact data from a blog, the potential change impact data from social media without video, or the potential change data from social media with video for the at least one third system.

16. The computer program product of claim 15, wherein the second ML model is trained using a K-nearest neighbors nomination (KNN) algorithm.

17. The computer program product of claim 12, wherein the third ML model is trained using a linear regression algorithm.

18. The computer program product of claim 12, wherein the third ML model is trained using a random forest algorithm.

19. The computer program product of claim 12, wherein the change request represents a change that will affect the environment of the second system.

20. A system comprising:
a processor, a computer readable memory, one or more computer readable storage media, and program instructions collectively stored on the one or more computer readable storage media, the program instructions executable to:
receive a change request for an environment from a first system;
predict an impact of the change request of the second system using a first machine learning (ML) model and output an existing system prediction impact based on the predicted impact of the change request of the second system;
predict the impact of the change request of at least one third system using a second ML model and output a dependent system prediction impact based on the predicted impact of the change request of the at least one third system;
receive historical impact data associated with the change request from a knowledge base;
generate an overall predictive score (OPS) based on the existing system prediction impact, the dependent system prediction impact, and the historical impact data; and
send an approval decision output signal based on a third ML model which is trained on the OPS, wherein the first ML model and the second ML model is trained using a K-nearest neighbors nomination (KNN) algorithm, and the third ML model is trained using a linear regression algorithm.
